(19) United States
(12) Patent Application Publication
(10) Pub. No.: US 2009/0293446 A1
(43) Pub. Date: Dec. 3, 2009

(54) Method for low NOx combustion with low pressure drop

(76) Inventors: Shahrokh Etemad, Trumbull, CT (US); William C. Pfefferle, Madison, CT (US); Benjamin Baird, Rocky Hill, CT (US)

Correspondence Address: Robert L. Rispoli;Precision Combustion, Inc., 410 Sackett Point Road, North Haven, CT, 06473, US

(21) Appl. No.: 11/903,131

(22) Filed: Sep. 19, 2007

Related U.S. Application Data
(60) Provisional application No. 60/846,489, filed on Sep. 22, 2006.

(51) Int. Cl. F02C 7/057

(52) U.S. Cl. 60/39.23

(57) ABSTRACT

The present invention provides a method for the reduction of pressure drop in low NOx combustion of fuel and air, maximizing energy efficiency. A supply of fuel and a supply of air form a fuel rich mixture that is reacted to produce partial reaction products and heat. A portion of the heat is transferred to a second supply of air. The partial reaction products are mixed with heated air and with a third supply of air to form a fuel lean admixture that is passed to a combustion zone for low NOx combustion.

### CROSS-REFERENCE

This application claims the benefit of U.S. Provisional Application No. 60/846,489 filed Sep. 22, 2006.

### FIELD OF THE INVENTION

The present invention relates to a method for ultra-low NOx combustion of fuels. The present invention provides a method for lowering combustor pressure drop in space limited turbines.

### BACKGROUND OF THE INVENTION

With energy usage directly related to economic growth, there has been a steady increase in the need for increased energy supplies. There is also a need to maximize the efficiency of energy use. Increase in energy use results in emissions of pollutants. Thus, there is a pressing need for power plants which are cleaner and more efficient. The need to reduce emissions can impact system efficiency. For gas turbines, low NOx combustion systems must exhibit pressure losses no higher than the system they replace in order to avoid efficiency loss and, except for new designs, fit within the engine. With NOx levels as low as 2 ppm now required, even for smaller turbines, it is crucial that compact, low pressure drop combustion systems be available.

Accordingly, improved combustion systems are needed. Thus the present invention is directed at allowing operation of an ultra-low NOx combustor at a lower pressure drop.

### SUMMARY OF THE INVENTION

It has now been found that using a reactor such as that described in U.S. Pat. No. 6,394,791, a portion of the combustion air can bypass the reactor and be admixed with the reactor product streams in the postmix zone without impairing emissions at the same fuel flows. Pressure drop is reduced since air flow through the reactor is reduced. In the present invention, a fuel rich mixture is partially combusted and a portion of the heat of reaction is transferred to a quantity of cooling air insufficient to yield low NOx combustion if premixed with said fuel. Both streams commingle on exiting the reactor and are immediately mixed with penetrating jets of additional combustion air to produce a product stream of a given equivalence ratio of a value suitable for low NOx combustion. The product stream may be combusted to yield a low NOx effluent.

### BRIEF DESCRIPTION OF THE DRAWINGS

FIG. 1 provides a diagrammatic representation of profile section of a combustion system and combustion of a fuel in accordance with the present invention.

### DETAILED DESCRIPTION OF THE INVENTION

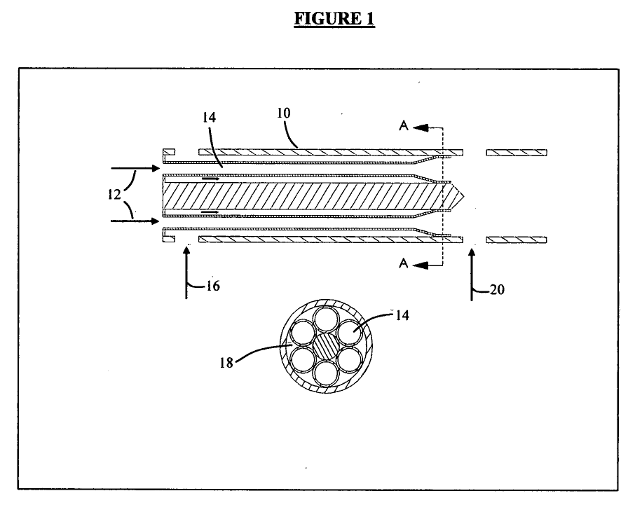

As shown for the example combustor 10 in FIG. 1, a portion of the reactor combustion air is mixed with the fuel to form a fuel rich mixture 16 which is passed to reactor 10 for partial oxidation on the catalytic exterior surfaces of tubes 14. A second portion of air 12 is passed through catalyst coated tubes 14 for backside catalyst cooling. Although shown as flared 18, unflared tubes may held in place by protrusions on the chamber walls.

On passage through reactor 10, a mixture of the two streams would have an equivalence ratio of a value too high for low NOx combustion. In order to form a mixture suitable for low NOx combustion, an amount of air 20 sufficient to lower the equivalence ratio to a value for low NOx combustion at the lower temperature is injected such that the three streams intermix. Flow recirculation should be avoided. Depending on the engine requirements, the amount of by-pass air required may be as little as ten or twenty percent of the total primary zone combustion air to over fifty percent, such as sixty or seventy percent. On combustion, NOx emissions of under one ppm have been obtained.

To illustrate the advantage of the present invention two designs were compared.

A conventional design using the methods of U.S. Pat. No. 6,394,791 was used to produce NOx emissions below three ppm for a small gas turbine. All the combustion air passes to the reactor with a design split of about eight percent to the catalyst channel and ninety two percent to the cooling tubes. Mixing of the two streams produced the equivalence ratio fed to the combustor. The maximum number of tubes that would fit in the allowable diameter were used, sixty one. In engine testing of a full engine set, pressure drop was greater than six percent. At full load, NOx was under three ppm with levels under one ppm at part load. Redesign to reduce pressure drop was needed but no space was available to increase reactor diameter.

To meet both the emission and efficiency goal, a unit of the present invention was designed and an engine set built. The new injectors are interchangeable with the conventional Dry Low NOx (DLN) commercial injectors. Using twenty eight of the same catalyst tubes as in the above reactor, slightly smaller diameter reactors were built and tested. Air flow comprised sixty percent bypass air and forty percent reactor air, as tested. The latter was divided six percent to the catalytic channels and thirty four percent to the cooling channels. For full load fuel flow, this represents an equivalence ratio of about 0.79, a value much too high for low NOx combustion. On injection of the bypass air into the exiting reactor streams, the equivalence ratio in the postmix zone was reduced to 0.317. Combustion NOx was 0.8 ppm and pressure drop less than three percent.

While the present invention has been described in considerable detail, other configurations exhibiting the characteristics taught herein for efficient and effective reactor heat transfer are contemplated. For example, other catalytic reactor designs are contemplated as well as non-catalytic gas phase combustion. Therefore, the spirit and scope of the invention should not be limited to the description of the preferred embodiments described herein.

1. The method of achieving low NOx in operation of a gas turbine combustion system comprising:
a) obtaining a supply of fuel;
b) obtaining a supply of air;
c) forming a fuel rich mixture of the fuel with a first percentage of the air;
d) reacting the fuel rich mixture to produce partial reaction products and heat;
e) transferring at least a portion of the heat to a second percentage of the air;
f) mixing the partial reaction products and heat with a third percentage of the air to form a lean fuel-air admixture; and
g) passing the admixture to a combustion zone for low NOx combustion.

2. The method of claim 1 wherein a mixture of the fuel with the first and second percentage of air is fuel lean.

3. The method of claim 1 wherein the fuel comprises methane.

4. The method of claim 1 wherein a mixture of the fuel with the first and second percentage of air is fuel rich.

5. The method of claim 1 wherein third percentage of air does not induce recirculation.
